(19) United States
(12) Patent Application Publication
(10) Pub. No.: US 2006/0037065 A1
(43) Pub. Date: Feb. 16, 2006

(54) Prevention of unauthorized credential production in a credential production system

(75) Inventors: John E. Ekers, Plymouth, MN (US); Gary M. Klinefelter, Eden Prairie, MN (US); Stacy W. Lukaskawcez, Shakopee, MN (US); Mark D. Oeltjenbruns, Shakopee, MN (US); Thomas A. Zappe, Fridley, MN (US)

Correspondence Address: Brian D. Kaul;Westman, Champlin & Kelly, Suite 1400, 900 Second Avenue South, Minneapolis, MN, 55402-3319, US

(73) Assignee: Fargo Electronics, Inc., Eden Prairie, MN (US)

(21) Appl. No.: 11/232,427

(22) Filed: Sep. 21, 2005

Related U.S. Application Data
(63) Continuation-in-part of application No. 10/372,011, filed on Feb. 21, 2003.
(63) Continuation-in-part of application No. 11/120,621, filed on May 3, 2005.
(60) Provisional application No. 60/611,614, filed on Sep. 21, 2004.
(60) Provisional application No. 60/373,967, filed on Apr. 19, 2002.
(60) Provisional application No. 60/361,253, filed on Mar. 1, 2002.
(60) Provisional application No. 60/567,734, filed on May 3, 2004.

(51) Int. Cl. H04L 9/32

(52) U.S. Cl. 726/5

(57) ABSTRACT

In a method for preventing unauthorized credential substrate processing in a credential production system that includes first and second credential production components, a first security code is generated using a random code and a first security key with the first credential production component. The first security code is communicated from the first credential production component to the second credential production component. The validity of the first security key is then checked using the first security code, the random code and a second security key with the second credential component. Finally, processing of the credential substrate by the credential production system is prevented when the first security key is not valid.

### CROSS-REFERENCE TO RELATED APPLICATION

The present application is based on and claims the benefit of U.S. Provisional Patent Application Ser. No. 60/611,614, filed Sep. 21, 2004, the content of which is hereby incorporated by reference in its entirety; is a continuation-in-part of U.S. patent application Ser. No. 10/372,011, filed Feb. 21, 2003 which is based on and claims the benefit of U.S. Provisional Patent Application Ser. No. 60/373,967, filed Apr. 19, 2002 and U.S. Provisional Application Ser. No. 60/361,253, filed Mar. 1, 2002; and the present application is a continuation-in-part of U.S. patent application Ser. No. 11/120,621, filed May 3, 2005 which is based on and claims the benefit of U.S. Provisional Patent Application Ser. No. 60/567,734, filed May 3, 2004. The contents of all of the above-referenced application are hereby incorporated by reference in their entirety.

### FIELD OF THE INVENTION

The present invention is generally directed to a credential production system and, more particularly, to methods of preventing unauthorized credential production in a credential production system.

### BACKGROUND OF THE INVENTION

Credentials include identification cards, driver's licenses, passports, and other documents. Such credentials are formed from credential substrates including paper substrates, plastic substrates, cards and other materials. Such credentials generally include printed information, such as a photo, account numbers, identification numbers, and other personal information. A secure overlaminate may also be laminated to the surfaces of the credential substrate to protect the surfaces from damage and, in some instances, provide a security feature (e.g., hologram). Additionally, credentials can include data that is encoded in a smartcard chip, a magnetic stripe, or a barcode, for example.

Credential manufacturing devices generally include at least one credential processing device that processes a credential substrate to perform at least one step in forming the final credential product. Such credential processing devices include, for example, printing devices for printing images to the credential substrate, laminating devices for laminating an overlaminate to the credential substrate, and encoding devices for encoding data to the substrate.

Conventionally, credential manufacturing devices, process a credential substrate in response to a credential processing job generated by a credential producing application. The credential processing job generally defines the printing, laminating and/or encoding processes that are to be performed by the credential manufacturing device on the credential substrate.

There is a great demand for security from unauthorized credential production. Some credential manufacturing systems include protections from such unauthorized credential production by limiting the use of consumable supplies with only specific credential manufacturing systems, such as disclosed in U.S. patent application Ser. No. 10/372,011, filed Feb. 21, 2003, for Identification Card Manufacturing Security, and assigned to Fargo Electronics, Inc. of Eden Prairie, Minn. While, such a security feature provides a significant barrier to unauthorized credential production, there is a continuous demand for additional security from unauthorized credential production.

Embodiments of the present invention provide solutions to these and other problems, and offer other advantages over the prior art.

### SUMMARY OF THE INVENTION

The present invention is generally directed to a method for preventing unauthorized credential substrate processing in a credential production system that includes first and second credential production components. In the method, a first security code is generated using a random code and a first security key with the first credential production component. The first security code is communicated from the first credential production component to the second credential production component. The validity of the first security key is then checked using the first security code, the random code and a second security key with the second credential component. Finally, processing of the credential substrate by the credential production system is prevented when the first security key is not valid.

### BRIEF DESCRIPTION OF THE DRAWINGS

FIG. 1 is a block diagram of a credential production system in accordance with embodiments of the invention.

FIGS. 2-4 are flowcharts illustrating methods for preventing unauthorized credential substrate processing in accordance with embodiments of the invention.

FIGS. 5-7 are flowcharts illustrating methods for checking the validity of a first security key in accordance with embodiments of the invention.

### DETAILED DESCRIPTION OF ILLUSTRATIVE EMBODIMENTS

As the issuance of identification and financial credentials comes under increased scrutiny for fraud, the ability to prevent the unauthorized manufacture of such credentials becomes more critical. Because of this lack of security, personnel inside of an organization have the means to produce fraudulent prints. For example, if the printer and its supplies are stolen, the printer can be used on another computer. If the printer has the wrong supplies installed, there is no way to avoid erroneous printing. If the supplies are valuable and need to be protected, there is no secure way to interrogate which supplies are available. One aspect of the present invention is directed to a system and method for preventing unauthorized manufacture of identification or financial credentials.

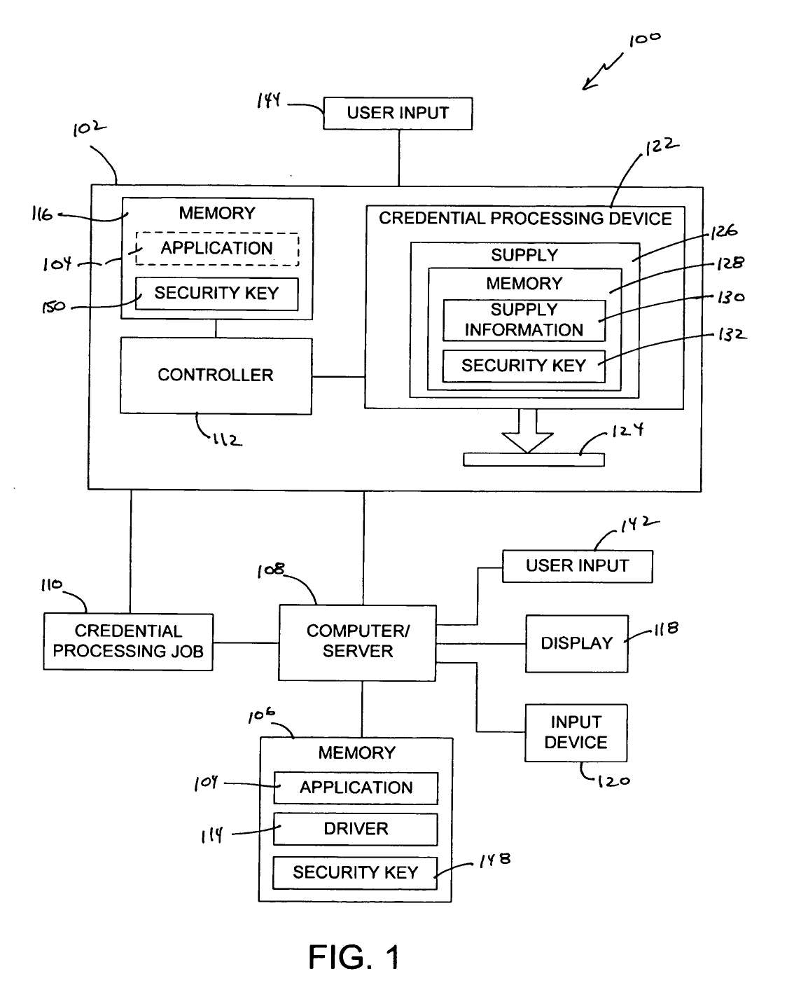

FIG. 1 is a schematic diagram of an exemplary credential production system 100 in accordance with embodiments of the invention. The system 100 generally includes credential production components including a credential production device 102 and a credential production application 104 stored in a computer-readable memory 106 that is accessible for execution by a computer or a host server 108.

The application 104 is configured to communicate with the credential production device 102 in accordance with conventional methods including a physical communication link (i.e., cable connection such as, for example, Universal Serial Bus), a wireless communication link, or a network communication link.

The application 104 is configured to generate a credential processing job 110 that includes processing instructions for the credential production device 102. The credential processing job is presented to a controller 112 of the credential production device 102 through a suitable driver application 114 stored in the memory 106 that is accessible by the computer or server 108 (hereinafter “computer”), for example. Alternatively, the application 104 can be stored in a computer-readable memory 116 of the credential production device 102. The user of the system 100 can view an application interface provided on a display 118 of the credential production system 100 and operate the application 104 through a suitable input device 120, such as a keyboard, mouse, etc., to form the credential processing job 110.

The credential production device 102 includes at least one credential substrate processing device 122 that is configured to process a credential substrate (e.g., card substrates, paper substrates, plastic substrates, substrates used to form passports, and other credential-related materials) 124 to perform at least one step in forming the final credential product (e.g. an identification card, a passport page, an employee badge, and other credentials) in response to the credential processing job 110. Exemplary credential substrate processing devices 122 include, for example, credential substrate printing devices (e.g., inkjet or thermal printhead) for printing images to the credential substrate 124, credential substrate laminating devices for laminating an overlaminate to the credential substrate 124, and credential substrate encoding devices for encoding data to the substrate 124. The methods of encoding data include writing a barcode on the substrate, recording data to magnetic stripe of the substrate, encoding data in a memory chip of the substrate, and other data encoding methods.

The credential production device 122 can include one or more consumable supplies 126. Exemplary supplies 126 include a supply of credential substrates (e.g., a cartridge or hopper containing the substrates) 124, a print consumable (e.g., ink or dye) for application to the substrate 124 by a printing device to print images to the substrate 124, an overlaminate supply for application to the substrate 124 by a laminating device, and other types of consumable supplies.

In accordance with one embodiment of the invention, the supply 126 includes a computer-readable memory 128. The memory 128 can include supply information 130 that identifies the supply 128 such as a part identifier, dealer information, a default quantity (e.g., starting amount) of the supply, a customer number, and a price for the supply, for example. Additionally, the consumable supply 128 can be a customized supply that includes security data, such as a customer specific security key and/or a password 132, in the memory 128, which can be used to determine whether the supply 126 is authorized for use with the credential production device 102, as described in U.S. patent application Ser. No. 10/372,011 and U.S. Pat. No. 6,832,866, both of which are assigned to Fargo Electronics, Inc., and are incorporated herein by reference in their entirety.

The controller 112 of the credential production device 102 is generally configured to process the credential substrate 124 using the credential processing device 122 in response to the credential processing job 110 produced by a user of the credential production application 104. The credential processing job 110 provides instructions for the credential production device 102 to perform the desired processing of the credential substrate 124. For example, a credential processing job 110 for processing a card substrate 124 to produce an identification card can include instructions for printing a photograph and personal information in accordance with a predefined layout. Additional exemplary instructions include laminating instructions for a laminating device to apply an overlaminate to a surface of the substrate 124, flipping instructions for a flipping or rotating device to flip the substrate 124, encoding instructions for a data encoding device to encode data to the substrate 124, and other processing instructions for the credential production device 102.

One embodiment of the invention is directed to a method for preventing unauthorized credential substrate processing in the credential production system 100. The method generally includes a security check of the application 104 and the credential production device 102 to determine whether the two components are authorized to process the credential substrate 124.

Embodiments of the method will be described with reference to first and second credential production components of the system 100 that include or have access to first and second security keys, respectively. In general, the first and second credential production components will each include either the application 104 or the credential production device 102, but not both. Embodiments of the credential production device 102 include one or more of the credential processing devices described above. In accordance with one embodiment of the invention, the first credential production component includes the application 104 and the second credential production component includes the credential production device 102. In accordance with another embodiment of the invention, the first credential production component includes the credential production device 102 and the second credential production component includes the application 104.

Embodiments of the security keys include an identifier that is unique to the credential production system 100. That is the first and second security keys of one credential production system will not match those of another system. Exemplary embodiments of the security keys include an identifier of the first credential production component (i.e., the credential production application 104 or the credential production device 102), an identifier of the second credential production component (i.e., the credential production application 104 or the credential production device 102), an identifier of a component of the credential production device 102, an identifier of a consumable supply 126 of the credential production device 102 (e.g., supply information 130 or security key 132), an identifier of an owner of the credential production system 100, an identifier of a dealer of the credential production system 100 (i.e., a customer-specific or dealer-specific security code), or other identifier that is preferably specific (i.e., unique) to the credential production device 102 or the credential production application 104.

It should be understood that the description of communications, calculations, code generations and other actions performed by the first and second credential production components include the use of corresponding microprocessors, memory and other components. For example, communication, calculation and code generation actions performed by the application 104 generally involve the processing of instructions contained in memory 106 by a microprocessor or controller, such as that of a computer 108, in accordance with conventional methods. Similarly, the communication, calculation and code generation actions performed by the credential production device 102 generally involve the processing of instructions contained in memory, such as memory 116, by the controller 112.

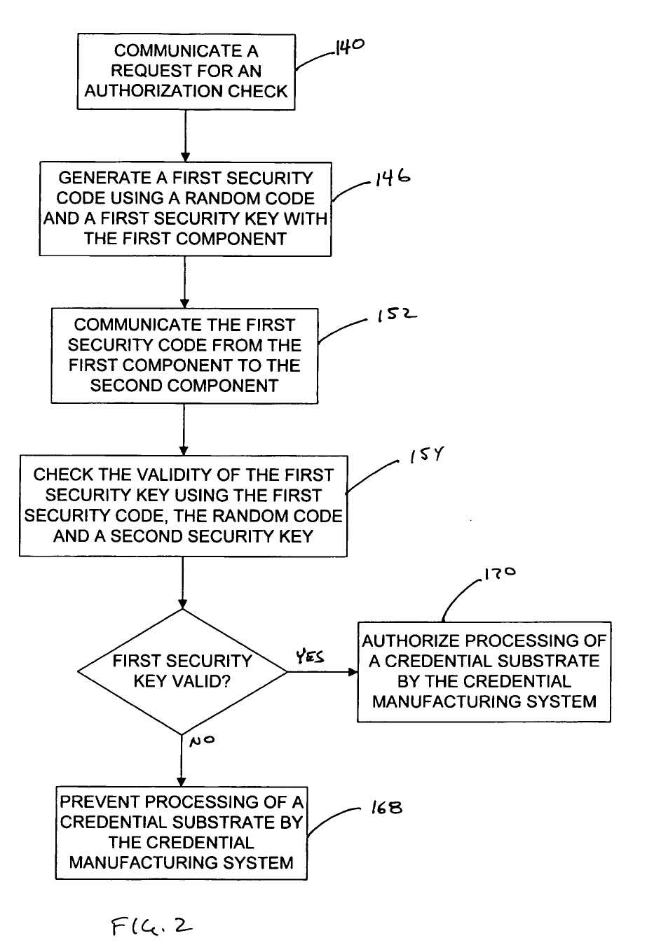

FIGS. 2-4 are flowcharts illustrating methods for preventing unauthorized credential substrate processing in accordance with embodiments of the invention. Same or similar method steps are identified by the same numbers. It should be understood that at least some of the steps described below can be performed in a different order than that presented in the flowcharts without departing from the spirit and scope of the invention. Additionally, other steps can be added and some of the steps can be removed without departing from the spirit and scope of the invention.

In accordance with one embodiment of the invention, a request for an authorization check is initially communicated between the first and second credential production components (hereinafter “first component” and “second component”, respectively), as indicated at step 140. The request can be sent in response to an initialization or start-up routine of the system 100, which can include the entering of an identification and password of the user of the system to the application (e.g. user input 142), the credential production device (e.g. user input 144), or both, for example. In general, the request is preferably sent prior to, along with, or after, the submission of a credential processing job 110 from the application 104 to the credential production device 102. Thus, for example, the request can be communicated upon starting or using the application 104, when the credential production device 102 is powered-on or enabled, upon sending the credential processing job 110 to the credential production device 102, upon beginning processing of the credential processing job 110 by the credential production device 102, upon completion of the credential processing job 110, upon submission of the credential processing job, or after the submission of the credential processing job 110 to the credential production device 102, but before completion of the processing of the credential processing job 110 by the credential production device 102.

At step 146 of the method shown in FIG. 2, the first component generates a first security code using a random code and a first security key. It should be understood that step 146 can follow (as implied in FIG. 2), coincide with, or occur prior to the step 140 of communicating a request for an authorization check.

The first security code generating step 146 of the method is preferably performed in accordance with a predefined encryption algorithm that uses the first security key and the random code. The encryption algorithm can be in accordance with any suitable method including Public Key Infrastructure (PKI), for example. As a result, the first security code is the encryption of the random code using first security key. Instructions for the encryption algorithm can be stored in memory that is accessible to the first component, such as in the computer-readable memory 106 when the first component is the application 104, or in the computer-readable memory 116 when the first component is the device 102, for example. The encryption algorithm instructions are executable by either the computer 108 or the controller 112. Alternatively, the first security code can be generated by an outside agent, which can be considered an element of the fist credential production device, that provides the first security code to the computer 108 or controller 112 of the corresponding first component.

In accordance with one embodiment of the invention, the random code and the first security key can comprise a numeric or alphanumeric code (i.e., 128 kbit) or other number. The random code can be contained in the memory or retrieved from another suitable source, as will be discussed below.

The security key 148 corresponding to the credential production application 104 (i.e., first or second security key depending on the embodiment of the invention) is preferably securely retrieved from a source that is accessible, or made accessible, to the microprocessor or controller of the computer 108 that executes the application 104. In accordance with one embodiment of the invention, the security key is not accessible to the credential production device 102. Exemplary sources of the security key 148 corresponding to the application 104 include the memory 106, a key card or other user input 142 such as from a user of the credential production system 100, program code of the credential production application 104, and other sources.

The security key 150 corresponding to the credential production device 102 (i.e., first or second security key depending on the embodiment of the invention) is also retrieved from a source, preferably in a secure manner. In accordance with one embodiment of the invention, the security key 150 is not accessible to the application 104. Exemplary sources of the security key 150 corresponding to the credential production device 102 include the memory 116 of the credential production device 102, the memory 128 of the supply 126, a memory that is remote from the credential production device (e.g., a memory that is accessible through a network connection), a key card or other user input 144 to the credential production device 102 such as from a user of the system 100, and other sources.

Next, at step 152 (FIG. 2), the first security code is communicated from the first component to the second component. A check of the validity of the first security key is performed using the first security code, the random code, and the second security key corresponding to the second component, at step 154. The validity checking step 154 can be performed by the first component, the second component, or other agent (e.g., program).

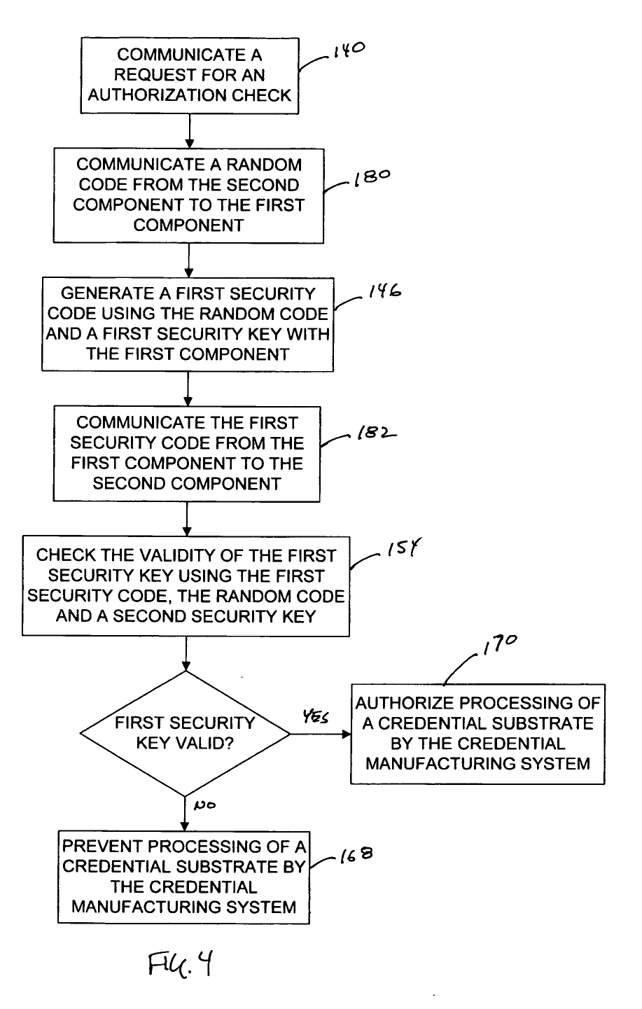

In accordance with one embodiment of the checking or validating step 154, the first security code is decrypted using the second security key in accordance with a decryption algorithm, as indicated at step 156 of the flowchart of FIG. 5. Instructions for the decryption algorithm can be stored in memory that is accessible to the second component, such as in the computer-readable memory 106 when the first component is the application 104, or in the computer-readable memory 116 when the second component is the device 102, for example. The decryption algorithm instructions can be executable by either the computer 108 or the controller 112, for example.

The decrypted first security code is then compared to the random number, at step 158. The first security key is deemed to be valid when the decrypted first security code has a predefined relationship to the random number. One embodiment of the predefined relationship is a match between the decrypted first security code and the random number. When such a match is found, the first and second security keys match and the encryption algorithm is reversed by the decryption algorithm. However, alternative, non-matching, predetermined relationships can also be used between the first and second security keys.

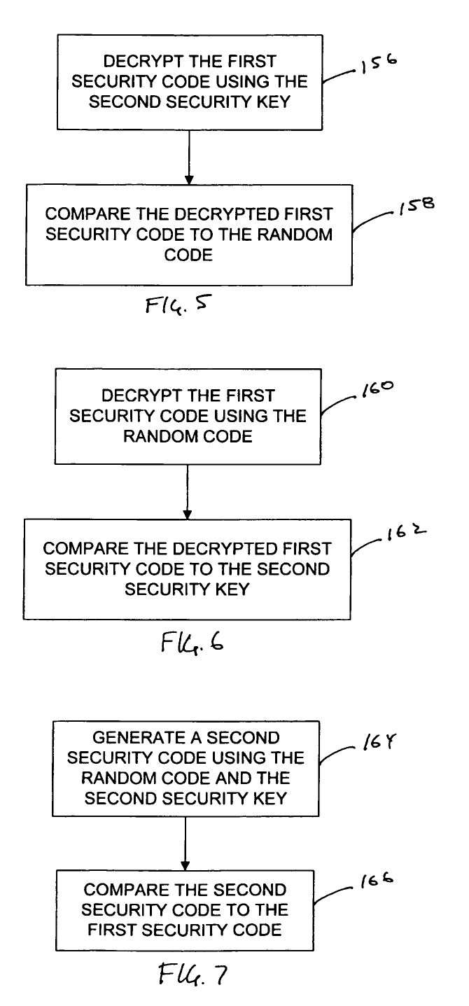

In accordance with another embodiment of the checking or validating step 154, the first security code is decrypted using the random number in accordance with the decryption algorithm, as indicated at step 160 of the flowchart of FIG. 6. The decrypted first security code is then compared to the second security key, at step 162. The first security key is deemed to be valid when the decrypted first security code has a predefined relationship to the second security key. One embodiment of the predefined relationship is a match between the decrypted first security code, which is preferably equal to the first security key, and the second security key. Thus, the encryption algorithm can be reversed by the decryption algorithm. However, alternative predetermined relationships can also be used.

In accordance with another embodiment of the checking or validating step 154, a second security code is generated using the random code and the second security key in accordance with an encryption algorithm, as indicated at step 164 of the flowchart of FIG. 7. Instructions for the encryption algorithm used in step 164 can be stored in memory that is accessible to the second credential production component, such as in the computer-readable memory 106 when the second component is the application 104, or in the computer-readable memory 106 when the second component is the device 102, for example. The encryption algorithm instructions are executable by either the computer 108 or the controller 112.

At step 166, the second security code is compared to the first security code. The first security key is deemed to be valid when the first security code has a predefined relationship to the second security code. One embodiment of the predefined relationship is a match between the first security code and the second security code. In general, such a match exists due to a match between the encryption algorithms and the first and second security keys. However, alternative predetermined relationships can also be used.

Referring again to FIG. 2, the processing of a credential substrate 124 by the credential production system 100 is prevented when the first security key is not valid, as indicated at step 168. The processing of the substrate 124 can be prevented in many different ways including disabling the device 102, preventing communication of the credential processing job 110 to the device 102, disabling the application 104, closing the communication between the application 104 and the device 102, and other suitable methods. When the processing of the substrate 124 is prevented, a notice can be provided to an administrator of the system 100, a warning can be provided to the user of the system 100, and an entry detailing the event can be stored in a log.

In accordance with one embodiment of the invention, the processing of the credential substrate 124 by the credential production device 102 in accordance with the credential processing job 110 is authorized or allowed when the first security key is valid, as indicated at step 170. Thus, depending on when the validity checking step 154 is performed, the validation of the first security key can be followed by allowing the user to form the credential processing job 110 using the application 104 and processing the substrate 124 (e.g., printing, laminating and/or encoding) using the credential processing device 102. The substrate processing event can be stored in a log that is accessible by the administrator of the system 100.

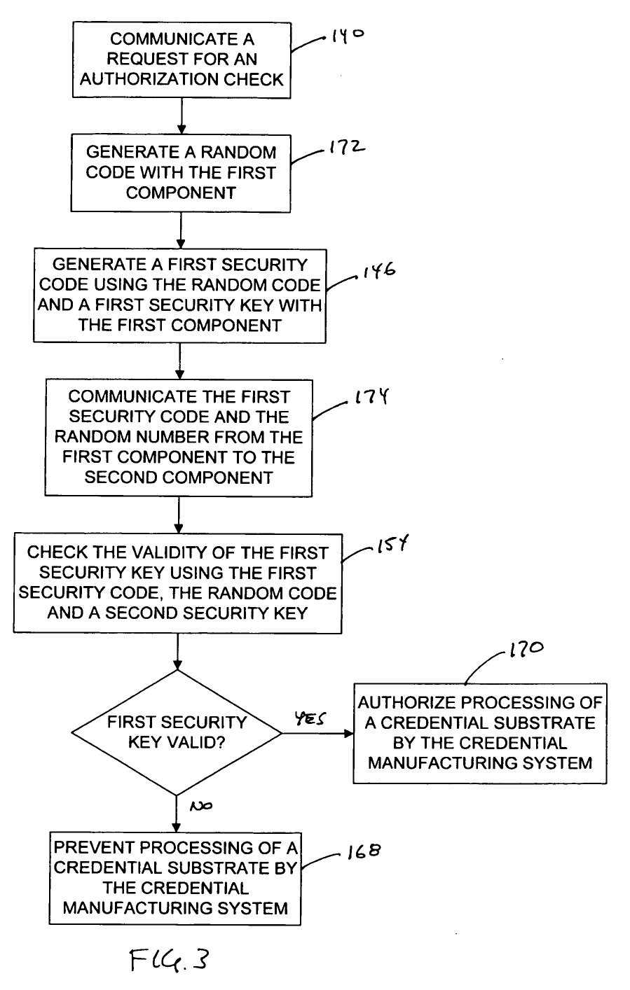

In accordance with the method illustrated in FIG. 3, the random code is generated, or otherwise obtained from an outside agent, by the first component at step 172. In accordance with embodiments of the invention, step 172 can follow (as implied in FIG. 3), coincide with, or occur prior to the step 140 of communicating a request for an authorization check. The random code can be generated in accordance with any suitable method including retrieving an existing random code, or instructions for generating the random code, from a memory that is accessible to the first component. Thus, for example, the random code can be obtained from, or generated through the execution of instructions contained in, memory that is accessible to the first component, such as in the computer-readable memory 106 when the first component is the application 104, or in the computer-readable memory 116 when the first component is the device 102, for example.

After the random code is obtained or generated by the first component, the first component generates the first security code at step 146 using the random code and the first security key, as described above. Next, at step 174, the first security code and the random code are communicated to the second credential production component through a suitable communication link. Finally, the validity of the first security key is checked at step 154 and the processing of a credential substrate 124 by the credential production system 100 is prevented when the first security key is not valid, as indicated at step 168 of FIG. 3, as described above. In accordance with one embodiment of the invention, the processing of the credential substrate 124 by the credential production device 102 in accordance with the credential processing job 110 is authorized or allowed when first security key is valid, as indicated at step 170 described above.

In accordance with the method illustrated in FIG. 4, the random code is communicated from the second credential production component to the first credential production component at step 180. In accordance with embodiments of the invention, step 180 can follow (as implied in FIG. 4), coincide with, or occur prior to the step 140 of communicating a request for an authorization check. The random code can be generated by the second credential production component, retrieved from memory, or obtained from an outside agent, in a similar manner as that described above with respect to the first credential production component in the method of FIG. 3. Next, the first credential production component generates the first security code at step 146, in accordance with the embodiments described above. The first security code is then communicated from the first credential production component to the second credential production component, at step 182. Finally, the validity of the first security key is checked at step 154 and the processing of a credential substrate 124 by the credential production system 100 is prevented when the first security key is not valid, as indicated at step 168 of FIG. 4, as described above. In accordance with one embodiment of the invention, the processing of the credential substrate 124 by the credential production device in accordance with the credential processing job 110 is authorized or allowed when first security key is valid, as indicated at step 170 described above.

Another aspect of the present invention is directed to preventing incomplete processing of a credential processing job 110. It is desirable to prevent such incomplete processing to reduce supply waste and to save time. In general, any one credential processing job 110 may involve several steps, each of which may utilize a different type of credential processing device 122, such as a data encoding device, a printing device, a laminating device, etc. Accordingly, to completely process the credential processing job 110, it is essential that the credential production device 102 include each of the necessary credential processing devices 122 and the necessary supplies 126, such as a print ribbon, an ink cartridge, overlaminate material (e.g., security overlaminate material), credential substrates, etc. In accordance with one embodiment of the invention, a check is made to determine whether each of the supplies 126 and/or the credential processing devices 122, that are necessary to complete the credential processing job 110 are available to the credential production device 102 prior to authorizing the processing of the job 110.

In accordance with one embodiment of the invention, the supplies 126 and devices 122 available to the credential production device 102 are identified in the memory 116, the memory 106, or in the memory 128, shown in FIG. 1. Accordingly, when a credential processing job 110 requires, for example, a specific credential substrate 124, ribbon supply, or security overlaminate supply, the challenge-response mechanism of the present invention provides a way to securely check to determine whether the credential production device 102 is prepared to handle the job 110 prior to authorizing it to process the job 110.

In accordance with yet another embodiment of the invention, other attributes of the system 100 are checked, such as the firmware version of the credential production device 102 contained in memory 116 prior to authorizing the processing of the job 110. For instance, a specific set of firmware may be required in a printer to print a specific security feature on a credential. If the printer firmware does not have the correct revision, then the printer would be unable to completely process the job. In that case, the device 102 would not be allowed to process the job 110.

In accordance with another embodiment of the invention, the credential processing job 110 (i.e., a print job, a laminating job, an encoding job, etc.) is encrypted with the random number used in the challenge-response method discussed above. This makes the encrypted print job 110 unique and prevents someone from simply relaying the job 110 to an unauthorized credential production device 102.

Another aspect of the invention is directed to a method of modifying an existing security key (i.e. security key 184 or 150) that is used in the encryption or decryption algorithms. Initially, a request is made by the first component (i.e., computer 108 and application 104 or credential production device 102) to the second component (i.e., the other of the computer 108 and application 104 or credential production device 102). The second component sends back a random code to the first component, which in turn generates a first portion of a change in security key request by encrypting the random number with the existing security key (e.g., a user input, a security code, etc.), and providing a second portion of the security key change request that includes a new security key that has been encrypted with the existing security key. The second component receives the encrypted random number portion of the security key change request and verifies that it correctly matches its own random number or encrypted random number. If a match exists, the second component can then decrypt the encrypted new security key to retrieve the new security key. Finally, the second component replaces the existing security key with the new security key.

Although the present invention has been described with reference to preferred embodiments, workers skilled in the art will recognize that changes may be made in form and detail without departing from the spirit and scope of the invention. For example, the steps of generating codes performed by the first or second credential production components could be performed by another component where the resultant code is then provided to the first or second credential production component. Thus, the term “generated” is intended to cover situations where the code (e.g., first or second security code, random code, etc.) is generated by an outside agent, but is then provided to the first or second credential production device. The outside agent can then be considered to be an element of the first or second component in those situations. Additionally, it should be understood that a security code that is generated using a random code and a security key can also be considered to be a random code.

What is claimed is:

1. A method for preventing unauthorized credential substrate processing in a credential production system including first and second credential production components, the method comprising steps of:
generating a first security code using a random code and a first security key with the first credential production component;
communicating the first security code from the first credential production component to the second credential production component;
checking the validity of the first security key using the first security code, the random code and a second security key with the second credential production component; and
preventing processing of a credential substrate by the credential production system when the first security key is not valid.

2. The method of claim 1, wherein the first credential production component includes a credential production application and the second credential production component includes a credential production device.

3. The method of claim 2, wherein the credential production device includes at least one credential substrate processing device selected from the group consisting of a credential substrate printing device, a credential substrate laminating device, and a credential substrate encoding device.

4. The method of claim 2 including:
retrieving the first security key from a source selected from the group consisting of a memory accessible to the computer, a key card input from a user of the credential production system, an input from user of the credential production system, and program code of the credential production application; and
retrieving the second security key from a source that is accessible to the credential production device selected from the group consisting of a memory of the credential production device, a memory that is remote from the credential production device, a key card input to the credential production device, and an input from user of the credential production system.

5. The method of claim 1, wherein the first credential production component includes a credential production device and the second credential production component includes a credential production application.

6. The method of claim 5, wherein the credential production device includes at least one credential substrate processing device selected from the group consisting of a credential substrate printing device, a credential substrate laminating device, and a credential substrate encoding device.

7. The method of claim 5 including:
retrieving the first security key from a source that is accessible to the credential production device selected from the group consisting of a memory of the credential production device, a memory that is remote from the credential production device, a key card input to the credential production device, and an input from user of the credential production system; and
retrieving the second security key from a source selected from the group consisting of a memory accessible to the computer, a key card input from a user of the credential production system, an input from user of the credential production system, and program code of the credential production application.

8. The method of claim 1 including performing a processing operation on the credential substrate with the credential production device when the first security key is valid, wherein the processing operation is selected from the group consisting of printing an image to the substrate, laminating a film to the substrate, and encoding data to the substrate.

9. The method of claim 1, wherein at least one of the first and second security keys is related to an identifier that is unique to the credential production system selected from the group consisting of an identifier of the credential production application, an identifier of the credential production device, an identifier of a component of the credential production device, an identifier of a consumable supply of the credential production device, an identifier of an owner of the credential production system, and an identifier of a dealer of the credential production system.

10. The method of claim 1 including communicating a request for an authorization check from one of the second credential production component to the first credential production component, and the first credential production component to the second credential production component, prior to the generating step.

11. The method of claim 1 including communicating the random code from the first credential production component to the second credential production component.

12. The method of claim 1 including communicating the random code from the second credential production component to the first credential production component.

13. The method of claim 1, wherein the checking step includes:
decrypting the first security code using the second security key; and
comparing the decrypted first security code to the random code;
wherein the first security key is deemed valid when a predetermined relationship exists between the decrypted first security code and the random code.

14. The method of claim 1, wherein the checking step includes:
decrypting the first security code using the random code; and
comparing the decrypted first security code to the second security key;
wherein the first security key is deemed valid when a predetermined relationship exists between the decrypted first security code and the second security key.

15. The method of claim 1, wherein the checking step includes:
generating a second security code using the random code and the second security key; and
comparing the second security code to the first security code;
wherein the first security key is deemed valid when a predetermined relationship exists between the first and second security codes.

16. A method for preventing unauthorized credential substrate processing in a credential production system including first and second credential production components, the method comprising steps of:
communicating a random code from the second credential production component to the first credential production component;
generating a first security code using the random code and a first security key;
communicating the first security code from the first credential production component to the second credential production component;
checking the validity of the first security key using the first security code, the random code and a second security key; and
preventing processing of a credential substrate by the credential production system when the first security key is not valid.

17. The method of claim 16, wherein the first credential production component includes a credential production application and the second credential production component includes a credential production device.

18. The method of claim 17, wherein the credential production device includes at least one credential substrate processing device selected from the group consisting of a credential substrate printing device, a credential substrate laminating device, and a credential substrate encoding device.

19. The method of claim 17 including:
retrieving the first security key from a source selected from the group consisting of a memory accessible to the computer, a key card input from a user of the credential production system, an input from user of the credential production system, and program code of the credential production application; and
retrieving a second security key from a source that is accessible to the credential production device selected from the group consisting of a memory of the credential production device, a memory that is remote from the credential production device, a key card input to the credential production device, and an input from user of the credential production system.

20. A method of claim 16, wherein the first credential production component includes a credential production device and the second credential production component includes a credential production application.

21. The method of claim 20, wherein the credential production device includes at least one credential substrate processing device selected from the group consisting of a credential substrate printing device, a credential substrate laminating device, and a credential substrate encoding device.

22. The method of claim 20 including:
retrieving the first security key from a source that is accessible to the credential production device selected from the group consisting of a memory of the credential production device, a memory that is remote from the credential production device, a key card input to the credential production device, and an input from user of the credential production system; and
retrieving the second security key from a source selected from the group consisting of a memory accessible to the computer, a key card input from a user of the credential production system, an input from user of the credential production system, and program code of the credential production application.

23. The method of claim 16 including performing a processing operation on the credential substrate with the credential production device when the first security key is valid, where the processing operation is selected from the group consisting of printing an image to the substrate, laminating a film to the substrate, and encoding data to the substrate.

24. The method of claim 16, wherein at least one of the first and second security keys is related to an identifier that is unique to the credential production systems selected from the group consisting of an identifier of the credential production application, an identifier of the credential production device, an identifier of a component of the credential production device, an identifier of a consumable supply of the credential production device, an identifier of an owner of the credential production system, and an identifier of a dealer of the credential production system.

25. The method of claim 16 including communicating a request for an authorization check from one of the second credential production component to the first credential production component, and the first credential production component to the second credential production component, prior to the step of communicating a random code.

26. The method of claim 16, wherein the checking step includes:
decrypting the first security code using the second security key; and
comparing the decrypted first security code to the random code;
wherein the first security key is deemed valid when a predetermined relationship exists between the decrypted first security code and the random code.

27. The method of claim 16, wherein the checking step includes:
decrypting the first security code using the random code; and
comparing the decrypted first security code to the second security key;
wherein the first security key is deemed valid when a predetermined relationship exists between the decrypted first security code and the second security key.

28. The method of claim 16, wherein the checking step includes:
generating a second security code using the random code and the second security key; and
comparing the second security code to the first security code;
wherein the first security key is deemed valid when a predetermined relationship exists between the first and second security codes.

29. A method for preventing unauthorized credential substrate processing in a credential production system including first and second credential production components, the method comprising steps of:
generating a first security code using a random code and a first security key;
communicating the first security code from the first credential production component to the second credential production component;
communicating the random code from the first credential production component to the second credential production component;
checking the validity of the first security key using the first security code, the random code and a second security key; and
preventing of a credential substrate by the credential production system when the first security key is not valid.

30. The method of claim 29, wherein the first credential production component includes the credential production application and the second credential production component includes the credential production device.

31. The method of claim 30, wherein the credential production device includes at least one credential substrate processing device selected from the group consisting of a credential substrate printing device, a credential substrate laminating device, and a credential substrate encoding device.

32. The method of claim 30 including:
retrieving the first security key from a source selected from the group consisting of a memory accessible to the computer, a key card input from a user of the credential production system, an input from user of the credential production system, and program code of the credential production application; and
retrieving a second security key from a source that is accessible to the credential production device selected from the group consisting of a memory of the credential production device, a memory that is remote from the credential production device, a key card input to the credential production device, and an input from user of the credential production system.

33. A method of claim 29, wherein the first credential production component includes the credential production device and the second credential production component includes the credential production application.

34. The method of claim 33, wherein the credential production device includes at least one credential substrate processing device selected from the group consisting of a credential substrate printing device, a credential substrate laminating device, and a credential substrate encoding device.

35. The method of claim 33 including:
retrieving the first security key from a source that is accessible to the credential production device selected from the group consisting of a memory of the credential production device, a memory that is remote from the credential production device, a key card input to the credential production device, and an input from user of the credential production system; and
retrieving the second security key from a source selected from the group consisting of a memory accessible to the computer, a key card input from a user of the credential production system, an input from user of the credential production system, and program code of the credential production application.

36. The method of claim 29 including performing a processing operation on the credential substrate with the credential production device when the first security key is valid, where the processing operation is selected from the group consisting of printing an image to the substrate, laminating a film to the substrate, and encoding data to the substrate.

37. The method of claim 29 wherein at least one of the first and second security keys is related to an identifier that is unique to the credential production systems selected from the group consisting of an identifier of the credential production application, an identifier of the credential production device, an identifier of a component of the credential production device, an identifier of a consumable supply of the credential production device, an identifier of an owner of the credential production system, and an identifier of a dealer of the credential production system.

38. The method of claim 29 including communicating a request for an authorization check from one of the second credential production component to the first credential production component, and the first credential production component to the second credential production component, prior to the step of generating a first security code.

39. The method of claim 29, wherein the checking step includes:
decrypting the first security code using the second security key; and
comparing the decrypted first security code to the random code;
wherein the first security key is deemed valid when a predetermined relationship exists between the decrypted first security code and the random code.

40. The method of claim 29, wherein the checking step includes:
decrypting the first security code using the random code; and
comparing the decrypted first security code to the second security key;
wherein the first security key is deemed valid when a predetermined relationship exists between the decrypted first security code and the second security key.

41. The method of claim 29, wherein the checking step includes:
generating a second security code using the random code and the second security key; and
comparing the second security code to the first security code;
wherein the first security key is deemed valid when a predetermined relationship exists between the first and second security codes.
